(19) United States
(12) Patent Application Publication
(10) Pub. No.: US 2026/0367357 A1
(43) Pub. Date: Nov. 19, 2026

(54) OPTICAL IMAGING LENS, IMAGING DEVICE AND ELECTRONIC DEVICE

(71) Applicants: ETERGE OPTO-ELECTRONICS CO., LTD., Taichung City (TW); ZHONG YANG TECHNOLOGY CO., LTD., Taichung City (TW)

(72) Inventors: CHIH-CHENG HSU, Taichung City (TW); CHIA-YI KO, Taichung City (TW); PO-NIEN TSAI, Taichung City (TW); TSU-MENG LEE, Taichung City (TW)

(21) Appl. No.: 19/466,705

(22) Filed: Feb. 2, 2026

(30) Foreign Application Priority Data
May 19, 2025 (TW) 114118622

(51) Int. Cl. G02B 9/62

(52) U.S. Cl. CPC G02B 9/62

(57) ABSTRACT

An optical imaging lenses include, from an object side to an image side, a first lens having negative refractive power and including an object-side surface being convex and an image-side surface being concave, the second lens having negative refractive power and including an object-side surface being convex and an image-side surface being concave, a third lens having positive refractive power and including an object-side surface being convex and an image-side surface being concave, an aperture, a forth lens having positive refractive power and including an object-side surface being convex and an image-side surface being convex, a fifth lens having negative refractive power and including an object-side surface being concave and an image-side surface being concave, and a sixth lens having positive refractive power and including an object-side surface being convex and an image-side surface being convex. The optical imaging lenses include a total of six lenses.

### BACKGROUND OF INVENTION

This invention relates to an optical imaging lens and an imaging device, particularly an optical imaging lens suitable for general electronic devices, small and medium-sized aerial vehicles (such as unmanned aerial vehicles, UVAs) or vehicle camera devices, and an imaging device and electronic device equipped with such an optical imaging lens.

### PRIOR ART

With advancements in semiconductor manufacturing processes, image sensors in photographic devices (e.g., CCD and CMOS Image Sensors) can meet the requirements for miniaturization, facilitating the production of miniaturized cameras. This trend has driven digital electronic products to incorporate miniaturized cameras for imaging functionality. Beyond the trend of miniaturization, photographic devices also need to meet consumer usage requirements for higher resolution, superior lens specifications (e.g., larger aperture ratios, wider field of view), and reduced manufacturing costs.

With the diversified development of electronic imaging devices, their applications have become increasingly broad, including advanced driver-assistance systems (ADAS), aerial photography equipment, smartphones, and human-machine interaction devices. Accordingly, the design requirements for optical lenses have become more diverse. In the case of optical lenses used in small and medium-sized aerial vehicles, due to constraints on space, weight, and power, such optical lenses not only require lightweight and compact designs but must also provide high resolution and sufficient luminous flux to enhance ground object mapping and distance determination functions. Furthermore, these optical lenses should have good adaptability to variations in temperature, humidity, and vibration. In addition, in order to ensure accurate image recognition during flight, such optical lenses must also effectively control various aberrations, particularly distortion and field curvature, thereby reducing adverse effects in subsequent image overlay, navigation calibration, and 3D modeling operations, and improving the accuracy of these operations.

Therefore, designing an optical imaging device that achieves a balance among miniaturization, high resolution, and excellent optical imaging quality has become a primary objective for those skilled in the art.

### SUMMARY OF THE INVENTION

In order to address the foregoing issues, the present invention provides an optical imaging lens, which, in order from an object side to an image side, comprises a first lens having negative refractive power with an object-side surface being convex and an image-side surface being concave; a second lens having negative refractive power with an object-side surface being convex and an image-side surface being concave; a third lens having positive refractive power with an object-side surface being convex and an image-side surface being concave; an aperture stop; a fourth lens having positive refractive power with an object-side surface being convex and an image-side surface also being convex; a fifth lens having negative refractive power with an object-side surface being concave and an image-side surface being concave; and a sixth lens having positive refractive power with an object-side surface being convex and an image-side surface being convex. A thickness of the second lens is CT2, a thickness of the first lens is CT1, and an air gap between the first lens and the second lens is AT12, a curvature radius of an object-side surface of the first lens is R1, such that the following conditions are satisfied:

−0.21<(CT2-CT1)/AT12<0.01;

and 18.4<R1/CT1<42.3.

The present invention further provides an optical imaging lens, which, in order from an object side to an image side, comprises a first lens having negative refractive power with an object-side surface being convex and an image-side surface being concave; a second lens having negative refractive power with an object-side surface being convex and an image-side surface being concave; a third lens having positive refractive power with an object-side surface being convex and an image-side surface being concave; an aperture stop; a fourth lens having positive refractive power with an object-side surface being convex and an image-side surface also being convex; a fifth lens having negative refractive power with an object-side surface being concave and an image-side surface being concave; and a sixth lens having positive refractive power with an object-side surface being convex and an image-side surface being convex. A thickness of the second lens is CT2, a thickness of the first lens is CT1, and an air gap between the first lens and the second lens is AT12, a curvature radius of an object-side surface of the second lens is R3, such that the following conditions are satisfied:

−0.21<(CT2-CT1)/AT12<0.01;

and 30.9<R3/CT2<50.5.

According to an embodiment of the present invention, wherein a curvature radius of an object-side surface of the first lens is R1, and a focal length of the first lens is f1, such that the following condition is satisfied:

−3<R1/f1<−1.3.

According to an embodiment of the present invention, wherein a curvature radius of an object-side surface of the second lens is R3, and a focal length of the second lens is f2, such that the following condition is satisfied:

−7.7<R3/f2<−4.6.

According to an embodiment of the present invention, wherein a curvature radius of an object-side surface of the the second lens is R3, a focal length of the optical imaging lens is EFL, and the following condition is satisfied:

−7.4<R3/EFL<12.7.

According to an embodiment of the present invention, wherein a focal length of the second lens is f2, a focal length of the optical imaging lens is EFL, and the following condition is satisfied:

−1.8<f2/EFL<−1.3.

According to an embodiment of the present invention, wherein a thickness of the third lens is CT3, a thickness of the fourth lens is CT4, an air gap from the third lens to the fourth lens is AT34, such that the following condition is satisfied:

1.3<(CT3+CT4)/AT34<3.9.

According to an embodiment of the present invention, wherein a thickness of the first lens is CT1, a thickness of the fifth lens is CT5, such that the following condition is satisfied:

1.1<CT1/CT5<2.6.

According to an embodiment of the present invention, wherein an air gap between the first lens and the second lens is AT12, and an air gap between the fifth lens and the sixth lens is AT56, such that the following condition is satisfied:

4.1<AT12/AT56<15.1.

According to an embodiment of the present invention, wherein an air gap between the third lens and the fourth lens is AT34, and a focal length of the optical imaging lens is EFL, such that the following condition is satisfied:

0.3<AT34/EFL<0.82.

According to an embodiment of the present invention, wherein a focal length of the optical imaging lens is EFL, a thickness of the fifth lens is CT5, such that the following condition is satisfied:

4.3<EFL/CT5<9.1.

According to an embodiment of the present invention, wherein a focal length of the fourth lens is f4, a focal length of the fifth lens is f5, a focal length of the optical imaging lens is EFL, such that the following condition is satisfied:

0.14<(f4+f5)EFL<0.25.

In an embodiment of the present invention, a total track length of the optical imaging lens is TTL, and an air gap between the fifth lens and the sixth lens is AT56, such that the following condition is satisfied:

74<TTL/AT56<184.

In an embodiment of the present invention, a total track length of the optical imaging lens is TTL, and a thickness of the fifth lens is CT5, such that the following condition is satisfied:

28<TTL/CT5<65.

According to one embodiment of the present invention, wherein a curvature radius of an object-side surface of the the first lens is R1, a curvature radius of the image-side of the the first lens is R2, a focal length of the first lens is f1, and the following condition is satisfied:

−3.6<(R1+R2)/f1<−1.7.

According to one embodiment of the present invention, wherein a focal length of the fifth lens is f5, a focal length of the sixth lens is f6, a thickness of the fifth lens is CT5, a thickness of the sixth lens is CT6; and the following condition is satisfied:

−0.1<(f5+f6)/(CT5+CT6)<−0.013.

According to one embodiment of the present invention, wherein the total thickness of the lenses of the optical imaging lens at the optical axis is ΣCT, and a thickness of the fifth lens is CT5, such that the following condition is satisfied:

11<ΣCT/CT5<26.1.

According to an embodiment of the present invention, wherein the sum of axial distances between each of adjacent lens of the optical imaging lens is ΣAT, and an air gap between the fourth lens and the fifth lens is AT45, such that the following condition is satisfied:

15<ΣAT/AT45<38.2.

According to an embodiment of the present invention, wherein a thickness of the fifth lens is CT5, a focal length of the fifth lens is f5, such that the following condition is satisfied:

−0.15<CT5/f5<−0.06.

A curvature radius of the object-side surface of the first lens of the optical imaging lens is R1, a curvature radius of the image-side surface of the first lens is R2, and the focal length of the first lens is f1, such that the following condition is satisfied:

−17<(R1*R2)/f1<−4.8.

According to one embodiment of the present invention, wherein a thickness of the fifth lens is CT5, a thickness of the sixth lens is CT6, a focal length of the fifth lens is f5, a focal length of the sixth lens is f6; such that the following condition is satisfied:

−79<(CT5+CT6)/(f5+f6)<−10.

According to one embodiment of the present invention, wherein a curvature radius of an object-side surface of the the first lens is R1, a curvature radius of the image-side of the the first lens is R2, and the following condition is satisfied:

2.8<R1/R2<5.1.

The present disclosure further provides an imaging device including the optical imaging lens as mentioned above and an image sensor; wherein the image sensor is located on an image plane of the optical imaging lens.

The present disclosure provides an electronic device including the imaging device as mentioned above.

### BRIEF DESCRIPTION OF THE DRAWINGS

FIG. 1A is a schematic view of an optical imaging lens according to a first embodiment of the present invention;

FIG. 1B, from left to right, shows the astigmatism/field curvature curves, the distortion curves, and the longitudinal spherical aberration curves of the optical imaging lens according to the first embodiment of the present invention;

FIG. 2A is a schematic view of an optical imaging lens according to a second embodiment of the present invention;

FIG. 2B, from left to right, shows the astigmatism/field curvature curves, the distortion curves and the longitudinal spherical aberration curves of the optical imaging lens according to the second embodiment of the present invention;

FIG. 3A is a schematic view of an optical imaging lens according to a third embodiment of the present invention;

FIG. 3B, from left to right, shows the astigmatism/field curvature curves, the distortion curves and the longitudinal spherical aberration curves of the optical imaging lens according to the third embodiment of the present invention;

FIG. 4A is a schematic view of an optical imaging lens according to a fourth embodiment of the present invention;

FIG. 4B, from left to right, shows the astigmatism/field curvature curves, the distortion curves and the longitudinal spherical aberration curves of the optical imaging lens according to the fourth embodiment of the present invention;

FIG. 5A is a schematic view of an optical imaging lens according to a fifth embodiment of the present invention;

FIG. 5B, from left to right, shows the astigmatism/field curvature curves, the distortion curves and the longitudinal spherical aberration curves of the optical imaging lens according to the fifth embodiment of the present invention;

FIG. 6A is a schematic view of an optical imaging lens according to a sixth embodiment of the present invention;

FIG. 6B, from left to right, shows the astigmatism/field curvature curves, the distortion curves and the longitudinal spherical aberration curves of the optical imaging lens according to the sixth embodiment of the present invention;

FIG. 7 is a schematic view of a small unmanned aerial vehicle according to a seventh embodiment of the present invention.

FIG. 8 is a schematic view of a general electronic device according to an eighth embodiment of the present invention;

### DETAILED DESCRIPTION OF THE INVENTION

In the following embodiments, the lenses of any optical imaging lens may be made of glass or plastic, without being limited to the materials specified in the embodiments. When the lens material is glass, the lens surface can be processed by grinding or molding. Additionally, glass material is resistant to temperature variations and with robust hardness, which can reduce the impact of environmental changes on the optical imaging lens and thereby extend its lifespan. When the lens material is plastic, it helps reduce the weight of the optical imaging lens and lower production costs.

In the embodiments of the present invention, each lens includes an object-side surface, facing the imaged object, and an image-side surface, facing the image plane. The surface shape of each lens is defined based on the shape of the surface near to the optical axis (paraxial region). For example, if the object-side surface of a lens is described as convex, it means that the object-side surface of the lens near to the optical axis is convex, although the surface in the off-axis region may be either convex or concave. The paraxial region shape of the each lens is determined by whether the curvature radius of the surface is positive or negative. For instance, if the curvature radius of the object-side surface of a lens is positive, the object-side surface is convex, and if the curvature radius of the object-side surface of a lens is negative, the object-side surface is concave; if the curvature radius of the image-side surface of a lens is positive, the image-side surface is concave, and if the curvature radius of the image-side surface of a lens is negative, the image-side surface is convex.

In the embodiments of the present invention, the object-side surface and the image-side surface of each lens can be spherical or aspherical. Using aspherical surfaces on lenses helps correct aberrations of the optical imaging lens, such as spherical aberration, and reduces the number of lenses used. However, incorporating aspherical lenses increases the overall cost of the optical imaging lens. In the embodiments of the present invention, the surfaces of some lenses are spherical but can be modified to aspherical as needed; similarly, the surfaces of some lenses are aspherical but it can be modified to spherical as needed.

In the embodiments of the present invention, the total track length (TTL) of the optical imaging lens is defined as the distance from the object-side surface of the first lens of the optical imaging lens to the image plane on the optical axis. The imaging height of the optical imaging lens, also called the maximum image height (ImgH). While an image sensor is installed on the image plane, ImgH represents half the diagonal length of the effective sensing area of the electronic image sensor. In the following embodiments, the TTL, ImgH, focal length, curvature radius of lenses, thickness of lenses, and the distances among each lens are measured in mm.

An optical imaging lens of the present invention, in order from an object side to an image side, comprises a first lens, a second lens, a third lens, an aperture stop, a fourth lens, a fifth lens and a sixth lens.

The first lens has a negative refractive power. Its object-side surface is convex while its image-side surface is concave. Preferably, the first lens is made of glass, which allows the optical imaging lens to operate reliably under conditions with relatively large temperature variations. In the embodiment of the present invention, the object-side surface or/and image-side surface of the first lens can be spherical to lower production cost and facilitate processing.

The second lens has a negative refractive power. Its object-side surface can be convex, and its image-side surface is concave. Preferably, the material of the second lens is made of glass, which allows the optical imaging lens to operate reliably under conditions with relatively large temperature variations. In the embodiments of the present invention, the object-side surface or/and image-side surface of the second lens can be spherical to lower production cost and facilitate processing.

The third lens has a positive refractive power. Its object-side surface can be convex, and its image-side surface is concave. Preferably, the material of the third lens can be plastic to lower production cost and facilitate processing. In the embodiments of the present invention, the object-side surface or/and image-side surface of the third lens can be aspherical, which can help to improve spherical aberration.

The fourth lens has a positive refractive power. Its object-side surface can be convex, and its image-side surface is also convex. Preferably, the material of the fourth lens can be plastic to lower production cost and facilitate processing. In the embodiments of the present invention, the object-side surface or/and image-side surface of the fourth lens can be aspherical, which can help to improve spherical aberration.

The fifth lens has a negative refractive power. Its object-side surface can be concave, and its image-side surface is also concave. Preferably, the material of the fifth lens is plastic to lower production cost and facilitate processing. In the embodiments of the present invention, the object-side surface or/and image-side surface of the fifth lens can be aspherical, which can help to improve spherical aberration.

The sixth lens has a positive refractive power. Its object-side surface can be convex, and its image-side surface is also convex. Preferably, the material of the sixth lens is made of glass, which allows the optical imaging lens to operate reliably under conditions with relatively large temperature variations. In the embodiments of the present invention, the object-side surface or/and image-side surface of the sixth lens can be can be aspherical, which can help to improve spherical aberration.

The thickness of the second lens in the optical imaging lens is CT2, the thickness of the first lens is CT1, and the air gap from the first lens to the second lens is AT12, such that the following condition is satisfied:

−0.21<(CT2-CT1)/AT12<0.01. (1)

When condition (1) is satisfied, the first lens and the second lens work in conjunction to help achieve a balance between the aperture size and the volume distribution.

A curvature radius of the object-side surface of the first lens of the optical imaging lens is R1, and a thickness of the first lens is CT1, such that the following condition is satisfied:

18.4<R1/CT1<42.3. (2)

When condition (2) is satisfied, the relationship between the curvature and thickness of the object-side surface of the first lens is balanced, thereby enhancing optical path control on the object side of the third lens.

A curvature radius of the object-side surface of the second lens of the optical imaging lens is R3, and a thickness of the second lens is CT2, such that the following condition is satisfied:

30.9<R3/CT2<50.5. (3)

When condition (3) is satisfied, the relationship between the curvature and thickness of the object-side surface of the second lens is balanced, thereby enhancing optical path control on the object side of the third lens.

A curvature radius of the object-side surface of the first lens of the optical imaging lens is R1, and a focal length of the first lens is f1, such that the following condition is satisfied:

−3<R1/f1<−1.3. (4)

When condition (4) is satisfied, the surface shape and refractive power of the first lens are adjusted, which helps reduce the overall volume and balance the volume distribution between the object-side end and the image-side end.

A curvature radius of the object-side surface of the second lens of the optical imaging lens is R3, and a focal length of the second lens is f2, such that the following condition is satisfied:

−7.7<R3/f2<−4.6. (5)

When condition (5) is satisfied, the surface shape and refractive power of the second lens are adjusted, which helps reduce the overall volume and balance the volume distribution between the object-side end and the image-side end.

A curvature radius of an object-side surface of the the second lens is R3, a focal length of the optical imaging lens is EFL, and the following condition is satisfied:

7.4<R3/EFL<12.7. (6)

When condition (6) is satisfied, the configuration of the convex and concave surfaces of the second lens is facilitated, thereby correcting the Petzval sum and making the image plane flatter.

A focal length of the second lens of the optical imaging lens is f2, and a focal length of the optical imaging lens is EFL, such that the following condition is satisfied:

−1.8<f2/EFL<−1.3. (7)

When condition (7) is satisfied, the refractive power of the second lens is adjusted to correct aberrations.

A thickness of the third lens of the optical imaging lens is CT3, the thickness of the fourth lens is CT4, the air gap between the third lens and the fourth lens of the optical imaging lens is AT34, such that the following condition is satisfied:

1.3<(CT3+CT4)/AT34<3.9 (8)

When condition (8) is satisfied, the thicknesses of the third and fourth lenses and the air gap therebetween are adjusted to correct aberrations.

A thickness of the first lens of the optical imaging lens is CT1, the thickness of the fifth lens is CT5, such that the following condition is satisfied:

1.1<CT1/CT5<2.6. (9)

When condition (9) is satisfied, the first lens and the fifth lens work in conjunction to correct aberrations and reduce the outer diameter at the object-side end of the optical imaging lens.

An air gap between the first lens and the second lens of the optical imaging lens is AT12, the air gap between the fifth lens and the sixth lens of the optical imaging lens is AT56, such that the following condition is satisfied:

4.1<AT12/AT56<15.1. (10)

When condition (10) is satisfied, the light path and light beam are controlled to facilitate aberration correction and enhance resolution.

An air gap between the third lens and the fourth lens of the optical imaging lens is AT34, and a focal length of the optical imaging lens is EFL, such that the following condition is satisfied:

0.3<AT34/EFL<0.82. (11)

When condition (11) is satisfied, the lens arrangement is adjusted to facilitate balancing the volume distribution of the imaging lens assembly.

The focal length of the optical imaging lens is EFL, the thickness of the fifth lens is CT5, and the following condition is satisfied:

4.3<EFL/CT5<9.1. (12)

When condition (12) is satisfied, the ratio between the focal length and the thickness of the fifth lens is adjusted to help enlarge the field of view.

A focal length of the fourth lens of the optical imaging lens is f4, a focal length of the fifth lens is f5, and a focal length of the optical imaging lens is EFL, such that the following condition is satisfied:

0.14<(f4+f5)EFL<0.25. (13)

When condition (13) is satisfied, it facilitates correction of spherical chromatic aberration while maintaining the stability of the overall system focal length.

The total track length of the optical imaging lens is TTL, the air gap between the fifth lens and the sixth lens of the optical imaging lens is AT56, such that the following condition is satisfied:

74<TTL/AT56<184. (14)

When condition (14) is satisfied, the spatial arrangement between the fifth and sixth lenses is balanced during miniaturization, which reduces the sensitivity of the imaging lens assembly and the impact of assembly tolerances.

The total track length of the optical imaging lens is TTL, the thickness of the fifth lens is CT5, such that the following condition is satisfied:

28<TTL/CT5<65. (15)

When condition (15) is satisfied, appropriate control of the relationship between the central thickness of the fifth lens and the total track length facilitates correction of aberrations in the on-axis field of view and enhances the imaging performance of the optical lens.

A curvature radius of the object-side surface of the first lens of the optical imaging lens is R1, and a curvature radius of the image-side surface of the first lens is R2, and a focal length of the first lens is f1, such that the following condition is satisfied:

−3.6<(R1+R2)/f1<−1.7. (16)

When condition (16) is satisfied, the surface shape and refractive power of the first lens is adjusted to correct aberrations.

A focal length of the fifth lens of the optical imaging lens is f5, a focal length of the sixth lens is f6, the thickness of the fifth lens is CT5, and the thickness of the sixth lens is CT6, such that the following condition is satisfied:

−0.1<(f5+f6)/(CT5+CT6)<−0.013. (17)

When condition (17) is satisfied, variations in spherical aberration and chromatic aberration of the optical system are effectively controlled, thereby making it easier to correct spherical aberration and chromatic aberration in the optical system.

In the optical imaging lens assembly, the total thickness of the lenses of the optical imaging lens at the optical axis is ECT, a thickness of the fifth lens is CT5, and the following condition is satisfied:

11<ΣCT/CT5<26.1. (18)

When condition (18) is satisfied, the fifth lens has sufficient thickness to help correct higher-order aberrations generated in a wide-angle photographic lens system, and the lens distribution can be adjusted to reduce the overall volume.

In the optical imaging lens assembly, the lenses of the optical imaging lens are separated from each other by gaps, and the total width of these gaps at the optical axis is ΣAT, and an air gap between the fourth lens and the fifth lens is AT45, wherein the following condition is satisfied:

15<ΣAT/AT45<38.2. (19)

When condition (19) is satisfied, the lens positions within the optical imaging lens assembly are evenly distributed, which helps balance the center of gravity of the optical imaging lens assembly. A thickness of the fifth lens of the optical imaging lens is CT5, the focal length of the fifth lens is f5, such that the following condition is satisfied:

−0.15<CT5/f5<−0.06. (20)

When condition (20) is satisfied, the thickness of the fifth lens is adjusted to facilitate the miniaturization of the electronic device.

A curvature radius of the object-side surface of the first lens of the optical imaging lens is R1, and a curvature radius of the image-side surface of the first lens is R2, and a focal length of the first lens is f1, such that the following condition is satisfied:

−17<(R1*R2)/f1<−4.8. (21)

When condition (21) is satisfied, the curvature of the first lens is adjusted to initially reduce spherical aberration and coma.

A thickness of the fifth lens of the optical imaging lens is CT5, the thickness of the sixth lens is CT6, the focal length of the fifth lens is f5, and the focal length of the sixth lens is f6, such that the following condition is satisfied:

−79<(CT5+CT6)/(f5+f6)<−10. (22)

When condition (22) is satisfied, it facilitates balancing the imaging quality and the module thickness.

A focal length of the fifth lens is f5 of the optical imaging lens, the curvature radius of the object-side surface of the first lens of the optical imaging lens is R1, and the curvature radius of the image-side surface of the first lens is R2, such that the following condition is satisfied:

2.8<R1/R2<5.1. (23)

When condition (23) is satisfied, thermal drift of the optical imaging lens assembly can be effectively reduced, which also facilitates correction of chromatic aberration.

### First Embodiment

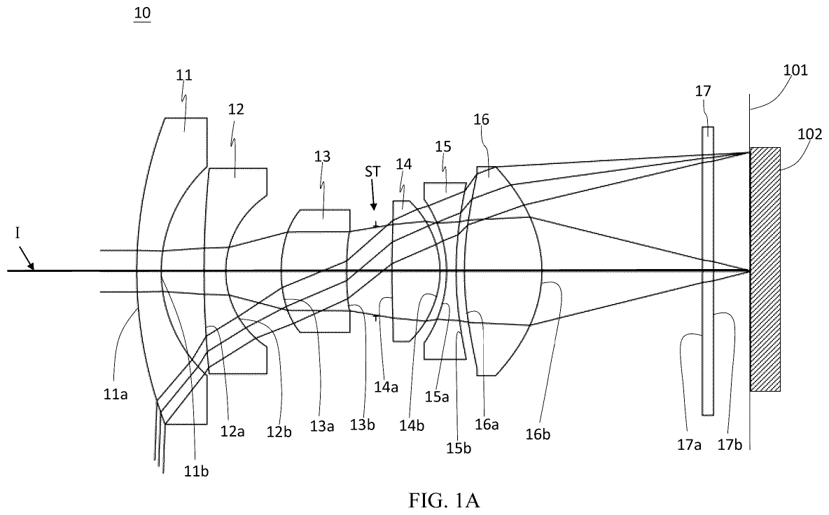

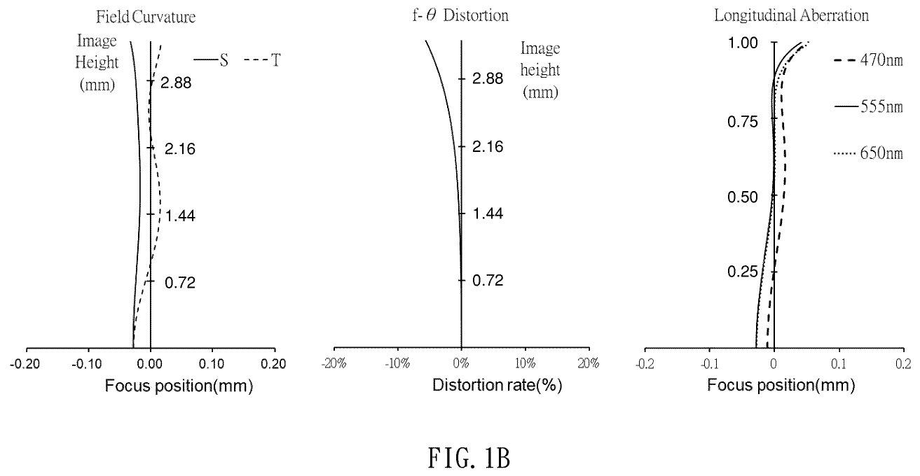

FIG. 1A is a schematic view of an optical imaging lens of a first embodiment according to the present invention. FIG. 1B, from left to right, shows the astigmatism/field curvature curves, f-θ distortion curves, and the longitudinal spherical aberration of the optical imaging lens according to the first embodiment.

As shown in FIG. 1A, the optical imaging lens 10 of the first embodiment includes, in order from an object side to an image side, a first lens 11, a second lens 12, a third lens 13, an aperture stop ST, a fourth lens 14, and a fifth lens and a sixth lens. The optical imaging lens 10 may further include a filter unit 17, and an image plane 101. An image sensor 102 could be disposed on the image plane 101 of the optical imaging lens 10 to form an imaging device (not labeled).

The first lens 11 has negative refractive power. Its object-side surface 11a is convex while its image-side surface 11b is concave. Both of the object-side surface 11a and the image-side surface 11b are spherical. The material of the first lens 11 includes glass, but is not limited thereto.

The second lens 12 has negative refractive power. Its object-side surface 12a is convex while its image-side surface 12b is concave. Both of the object-side surface 12a and the image-side surface 12b are spherical. The material of the first lens 12 includes glass, but is not limited thereto.

The third lens 13 has positive refractive power. Its object-side surface 13a is convex while its image-side surface 13b is concave. Both of the object-side surface 13a and the image-side surface 13b are spherical. The material of third lens 13 includes plastic, but is not limited thereto.

The fourth lens 14 has positive refractive power. Its object-side surface 14a is convex and its image-side surface 14b is also convex. Both of the object-side surface 14a and the image-side surface 14b are aspheric. The material of fourth lens 14 includes plastic, but is not limited thereto.

The fifth lens 14 has negative refractive power. Its object-side surface 15a is concave and its image-side surface 15b is also concave. Both of the object-side surface 15a and the image-side surface 15b are aspheric. The material of the fifth lens 15 includes plastic, but is not limited thereto.

The sixth lens 16 has positive refractive power. Its object-side surface 16a is convex and its image-side surface 16b is also convex. Both of the object-side surface 16a and the image-side surface 16b are aspheric. The material of sixth lens 16 includes plastic, but is not limited thereto.

The filter unit 17 is positioned between the sixth lens 16 and the image plane 101 to filter out light of specific wavelength ranges, allowing the desired wavelengths to pass through. For example, it can be a component for filtering ultraviolet or far-infrared light. Both surfaces 17a and 17b of the filter unit 17 are flat, and the material is glass.

The image sensor 102 can be a CCD image sensor or CMOS image sensor.

Referring to Table 1, which provides the optical parameters of the optical imaging lens 10 of the first embodiment. In Table 1, the object-side surface 11a of the first lens 11 is denoted as surface 11a, the image-side surface 11b is denoted as surface 11b, and so on. The value in the distance column denotes a distance from a lens surface to a next lens surface on the optical axis I. For example, the distance from the object-side surface 11a to the image-side surface 11b is 0.662 mm, which means that a thickness of the first lens 11 is 0.662 mm. Similarly, the distance AT23 from the image-side surface 12b of the second lens 12 to the object-side surface 13a of the third lens 13 is 1.495 mm, and so on. In the first embodiment, the effective focal length of the optical imaging lens 10 is EFL, the maximum half field of view of the optical imaging lens 10 is HFOV. The values of HFOV of the optical imaging lens 10 are listed in Table 1.

TABLE 1
First Embodiment
TTL = 16.58 mm, EFL = 2.33 mm, FNO = 2, HFOV = 88°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | | | | |
| 1st lens | 11a | Spherical | 12.187 | 0.662 | 1.729 | 54.7 | −8.49 |
| | | Surface | | | | | |
| | 11b | Spherical | 4.021 | 1.158 | | | |
| | | Surface | | | | | |
| 2nd lens | 12a | Spherical | 29.560 | 0.586 | 1.729 | 54.7 | −3.84 |
| | | Surface | | | | | |
| | 12b | Spherical | 2.544 | 1.495 | | | |
| | | Surface | | | | | |
| 3rd lens | 13a | Aspherical | 3.714 | 1.768 | 1.661 | 20.4 | 7.43 |
| | | Surface | | | | | |
| | 13b | Aspherical | 12.000 | 0.789 | | | |
| | | Surface | | | | | |
| Aperture | ST | Flat | Infinity | 0.437 | | | |
| Stop | | | | | | | |
| 4th lens | 14a | Aspherical | 28.558 | 1.300 | 1.537 | 56.0 | 4.45 |
| | | Surface | | | | | |
| | 14b | Aspherical | −2.573 | 0.177 | | | |
| | | Surface | | | | | |
| 5th lens | 15a | Aspherical | −3.524 | 0.257 | 1.661 | 20.4 | −3.89 |
| | | Surface | | | | | |
| | 15b | Aspherical | 10.087 | 0.222 | | | |
| | | Surface | | | | | |
| 6th lens | 16a | Aspherical | 8.368 | 2.098 | 1.731 | 53.9 | 3.68 |
| | | Surface | | | | | |
| | 16b | Aspherical | −3.560 | 4.333 | | | |
| | | Surface | | | | | |
| Filter Unit | 17a | Flat | Infinity | 0.300 | 1.523 | 54.5 | inf |
| | 17b | Flat | Infinity | 1.000 | | | |
| Image Plane | 101 | Flat | Infinity | 0.000 | | | |

Reference Wavelength: 550 nm

Table 2 below lists the values of the aspherical surface coefficients of each lens surface in the first embodiment used, wherein K is the conic coefficient of the aspherical curve equation, and A4 to A16 are the 4nd order to the 16th order aspheric coefficients. For example, the conic coefficient K of the object-side surface 13a of the third lens 13 is 1.68E+00, and so on. In the following description, the tables for each of the optical imaging lenses of other embodiments use the same definition as the first embodiment. Therefore, the duplicated description would be omitted for brevity.

TABLE 2
First Embodiment _Aspherical Surface Coefficient

| | 13a | 13b | 14a | 14b | 15a | 15b | 16a | 16b |
|---|---|---|---|---|---|---|---|---|
| K | 1.68E+00 | 7.47E+01 | −9.00E+01 | −6.00E−01 | 0.00E+00 | 0.00E+00 | −1.01E+01 | −1.78E+00 |
| A4 | 1.72E−03 | 1.24E−02 | −1.82E−03 | −9.06E−05 | 6.76E−04 | −4.02E−04 | −6.50E−04 | −3.23E−03 |
| A6 | 2.10E−03 | 3.60E−05 | 1.32E−04 | −1.21E−04 | −1.51E−05 | 9.91E−07 | 1.11E−04 | 5.58E−05 |
| A8 | −6.17E−04 | 1.03E−03 | −5.38E−05 | −1.61E−04 | 3.59E−05 | −1.18E−05 | −1.59E−05 | 2.85E−06 |
| A10 | 1.17E−04 | −5.46E−05 | 5.95E−06 | 1.58E−06 | −7.87E−06 | 1.82E−07 | 7.37E−07 | −1.52E−07 |
| A12 | 0.00E+00 | 0.00E+00 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 | 0.00E+00 | 0.00E+00 |

In the first embodiment, the thickness of the second lens in the optical imaging lens is CT2, the thickness of the first lens is CT1, the air gap from the first lens to the second lens is AT12, (CT2-CT1)/AT12=−0.065.

In the first embodiment, the curvature radius of the object-side surface of the the first lens in the optical imaging lens is R1, the thickness of the first lens in the optical imaging lens is CT1, R1/CT1=18.418.

In the first embodiment, the curvature radius of the object-side surface of the the second lens in the optical imaging lens is R3, the thickness of the second lens in the optical imaging lens is CT2, R3/CT2=50.437.

In the first embodiment, the curvature radius of the object-side surface of the the first lens in the optical imaging lens is R1, and the focal length of the first lens is f1, R1/f1=−1.435.

In the first embodiment, the curvature radius of the object-side surface of the the second lens in the optical imaging lens is R3, and the focal length of the second lens is f2, R3/f2=−7.698.

In the first embodiment, the curvature radius of the object-side surface of the the second lens in the optical imaging lens is R3, and the focal length of the optical imaging lens is EFL, R3/EFL=12.687.

In the first embodiment, the focal length of the second lens in the optical imaging lens is f2, the focal length of the optical imaging lens is EFL, f2/EFL=−1.648.

In the first embodiment, the thickness of the third lens in the optical imaging lens is CT3, the thickness of the fourth lens is CT4, the air gap from the third lens to the fourth lens is AT34, (CT3+CT4)/AT34-3.89.

In the first embodiment, the thickness of the first lens in the optical imaging lens is CT1, the thickness of the fifth lens is CT5, CT1/CT5=2.579.

In the first embodiment, the air gap from the first lens to the second lens is AT12, the air gap from the fifth lens to the sixth lens is AT56, AT12/AT56=5.222.

In the first embodiment, the air gap from the third lens to the fourth lens is AT34, and the focal length of the optical imaging lens is EFL, AT34/EFL=0.339.

In the first embodiment, the focal length of the optical imaging lens is EFL, the thickness of the fifth lens is CT5, EFL/CT5-9.083.

In the first embodiment, the focal length of the fourth lens in the optical imaging lens is f4, the focal length of the fifth lens is f5, and the focal length of the optical imaging lens is EFL, (f4+f5) EFL=0.24.

In the first embodiment, the total track length of the optical imaging lens is TTL, the air gap from the fifth lens to the sixth lens is AT56, TTL/AT56-74.776.

In the first embodiment, the total track length of the optical imaging lens is TTL, the thickness of the fifth lens is CT5, TTL/CT5-64.632.

In the first embodiment, the curvature radius of the object-side surface of the the first lens in the optical imaging lens is R1, and the curvature radius of the image-side of the the first lens is R2, the focal length of the first lens is f1, (R1+R2)/f1=−1.908.

In the first embodiment, the focal length of the fifth lens is f5, the focal length of the sixth lens is f6, the thickness of the fifth lens is CT5, and the thickness of the sixth lens is CT6, (f5+f6)/(CT5+CT6)=−0.087.

In the first embodiment, the total thickness of the lenses of the optical imaging lens at the optical axis is ECT, a thickness of the fifth lens is CT5, ECT/CT5=26.003.

In the first embodiment, the lenses of the optical imaging lens are separated from each other by gaps, and the total width of these gaps at the optical axis is LAT, the air gap from the fourth lens to the fifth lens is AT45, EAT/AT45=21.681.

In the first embodiment, the thickness of the fifth lens is CT5, the focal length of the fifth lens is f5, CT5/f5=−0.066.

In the first embodiment, the curvature radius of the object-side surface of the the first lens in the optical imaging lens is R1, and the curvature radius of the image-side of the the first lens is R2, the focal length of the first lens is f1, (R1*R2)/f1=−5.769.

In the first embodiment, the thickness of the fifth lens is CT5, the thickness of the sixth lens is CT6, the focal length of the fifth lens is f5, and the focal length of the sixth lens is f6, (CT5+CT6)/(f5+f6)=−11.486.

In the first embodiment, the curvature radius of the object-side surface of the the first lens in the optical imaging lens is R1, and the curvature radius of the image-side of the the first lens is R2, R1/R2=3.031.

From the values of the above conditions, the optical imaging lens assembly 10 of the first embodiment satisfies the requirements of conditions (1) to (23).

FIG. 1B shows, in order from left to right, the astigmatism/field curvature curves, f-θ distortion curves, and the longitudinal spherical aberration curves of the optical imaging lens 10. It can be seen from the astigmatism/field curvature curve (wavelength 550 nm), the aberration in the sagittal direction(S) varies between −0.05 and 0.02 mm across the entire field of view, while the aberration in the tangential direction (T) varies between −0.03 and 0.02 mm. From the f-θ distortion curves (wavelength 550 nm), it is evident that the absolute value of the f-θ distortion rate of the optical imaging lens 10 is less than 8%. From the longitudinal spherical aberration curve, it can be seen that off-axis light rays at three infrared wavelengths—470 nm, 555 nm, and 650 nm—can all converge near the imaging point. The deviation of the imaging point can be controlled within the range of −0.03 to 0.05 mm. As shown in FIG. 1B, the optical imaging lens 10 of this embodiment has effectively corrected various aberrations, meeting the imaging quality requirements of the optical system.

### Second Embodiment

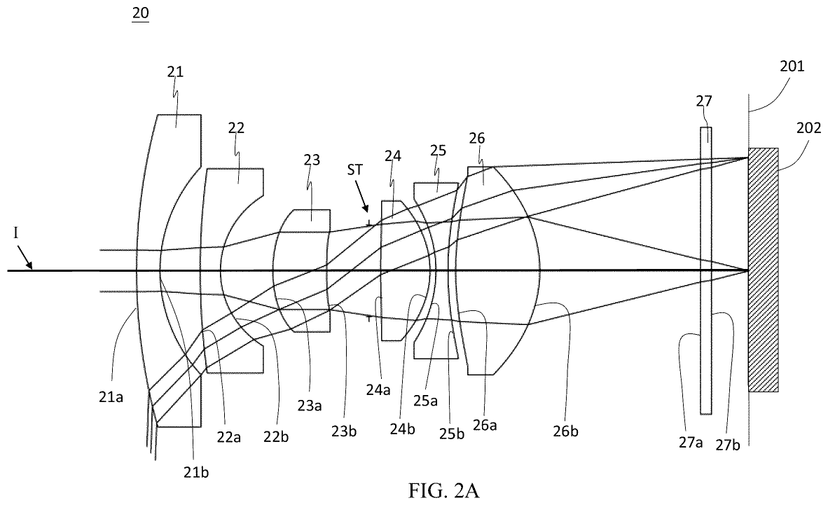

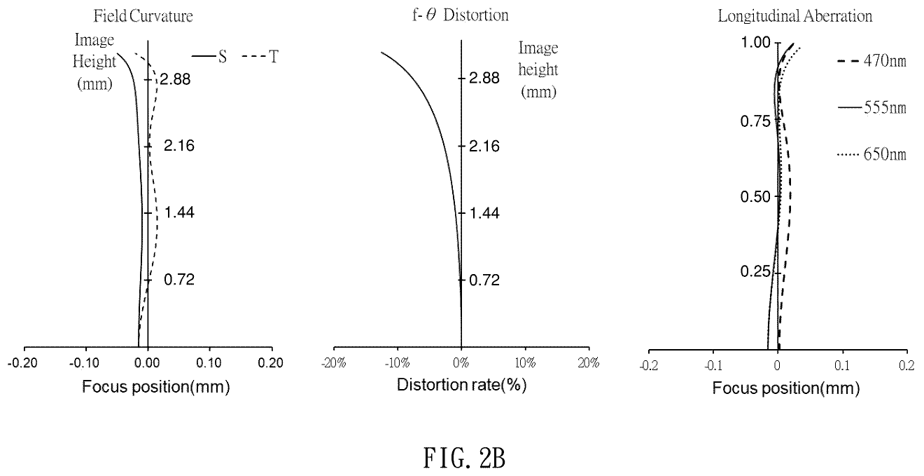

Referring to FIGS. 2A and 2B, FIG. 2A is a schematic view of an optical imaging lens of a second embodiment according to the present invention. FIG. 2B, from left to right, shows the astigmatism/field curvature curves, f-θ distortion curves, and the longitudinal spherical aberration curves of the optical imaging lens according to the second embodiment.

As shown in FIG. 2A, the optical imaging lens 20 of the second embodiment includes, in order from an object side to an image side, a first lens 21, a second lens 22, a third lens 23, and an aperture stop ST, a fourth lens 24, a fifth lens 25 and a sixth lens 26. The optical imaging lens 20 may further include a filter unit 27 and an image plane 201. An image sensor 202 can be disposed on the image plane 201 of the optical imaging lens 20 to form an imaging device (not labeled).

The first lens 21 has negative refractive power. Its object-side surface 21a is convex while its image-side surface 21b is concave. Both of the object-side surface 21a and the image-side surface 21b are spherical. The material of the first lens 21 includes glass, but is not limited thereto.

The second lens 22 has negative refractive power. Its object-side surface 22a is convex while its image-side surface 22b is concave. Both of the object-side surface 22a and the image-side surface 22b are spherical. The material of the second lens 22 includes glass, but is not limited thereto.

The third lens 23 has positive refractive power. Its object-side surface 23a is convex, while its image-side surface 23b is concave. Both of the object-side surface 23a and the image-side surface 23b are spherical. The material of third lens 23 includes plastic, but is not limited thereto.

The fourth lens 24 has positive refractive power. Its object-side surface 24a is convex, and its image-side surface 24b is also convex. Both of the object-side surface 24a and the image-side surface 24b are aspheric. The material of fourth lens 24 includes plastic, but is not limited thereto.

The fifth lens 25 has negative refractive power. Its object-side surface 25a is concave and its image-side surface 25b is also concave. Both of the object-side surface 25a and the image-side surface 25b are aspheric. The material of the fifth lens 25 includes plastic, but is not limited thereto.

The sixth lens 26 has positive refractive power. Its object-side surface 26a is convex and its image-side surface 26b is also convex. Both of the object-side surface 26a and the image-side surface 26b are aspheric. The material of sixth lens 26 includes plastic, but is not limited thereto.

The filter unit 27 is positioned between the sixth lens 26 and the image plane 201 to filter out light of specific wavelength, allowing the desired wavelengths to pass through. For example, it can be a component for filtering ultraviolet or far-infrared light. Both surfaces 27a and 27b of the filter unit 27 are flat, and the material is glass.

The image sensor 202 can be a CCD image sensor or CMOS image sensor.

The detailed optical data and aspherical coefficients of the lens surfaces for the optical imaging lens 20 in the second embodiment are listed in Table 3 and Table 4, respectively. In the second embodiment, the aspherical surface equation is expressed in the same form as in the first embodiment.

TABLE 23
Second Embodiment
TTL = 16.55 mm, EFL = 2.351 mm, FNO = 2, HFOV = 88°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | | | | |
| 1st lens | 21a | Spherical | 16.790 | 0.635 | 1.729 | 54.7 | −8.18 |
| | | Surface | | | | | |
| | 21b | Spherical | 4.341 | 1.087 | | | |
| | | Surface | | | | | |
| 2nd lens | 22a | Spherical | 21.472 | 0.548 | 1.729 | 54.7 | −3.88 |
| | | Surface | | | | | |
| | 22b | Spherical | 2.477 | 1.418 | | | |
| | | Surface | | | | | |
| 3rd lens | 23a | Aspherical | 3.646 | 1.454 | 1.661 | 20.4 | 7.25 |
| | | Surface | | | | | |
| | 23b | Aspherical | 12.425 | 1.148 | | | |
| | | Surface | | | | | |
| Aperture | ST | Flat | Infinity | 0.316 | | | |
| Stop | | | | | | | |
| 4th lens | 24a | Aspherical | 25.295 | 1.338 | 1.537 | 56.0 | 4.41 |
| | | Surface | | | | | |
| | 24b | Aspherical | −2.574 | 0.158 | | | |
| | | Surface | | | | | |
| 5th lens | 25a | Aspherical | −3.571 | 0.326 | 1.661 | 20.4 | −3.87 |
| | | Surface | | | | | |
| | 25b | Aspherical | 9.677 | 0.207 | | | |
| | | Surface | | | | | |
| 6th lens | 26a | Aspherical | 8.308 | 2.279 | 1.731 | 53.9 | 3.75 |
| | | Surface | | | | | |
| | 26b | Aspherical | −3.632 | 4.343 | | | |
| | | Surface | | | | | |
| Filter Unit | 27a | Flat | Infinity | 0.300 | 1.523 | 54.5 | inf |
| | 27b | Flat | Infinity | 1.000 | | | |
| Image Plane | 201 | Flat | Infinity | 0.000 | | | |

Reference Wavelength: 550 nm

TABLE 4
Second Embodiment _Aspherical Surface Coefficient

| | 23a | 23b | 24a | 24b | 25a | 25b | 26a | 26b |
|---|---|---|---|---|---|---|---|---|
| K | 1.94E+00 | 8.14E+01 | −9.01E+01 | −6.21E−01 | 0.00E+00 | 0.00E+00 | −1.07E+01 | −1.72E+00 |
| A4 | 3.53E−03 | 1.24E−02 | −2.91E−03 | 3.57E−05 | 8.54E−04 | −1.64E−04 | −6.22E−04 | −2.99E−03 |
| A6 | 2.02E−03 | 1.97E−04 | −1.34E−04 | −9.17E−06 | 4.46E−05 | −6.16E−05 | 7.40E−05 | 1.32E−05 |
| A8 | −6.26E−04 | 1.24E−03 | −1.25E−05 | −9.18E−05 | 3.45E−05 | −1.64E−05 | −1.48E−05 | 1.35E−06 |
| A10 | 1.72E−04 | −7.34E−05 | 2.37E−05 | 1.38E−05 | −6.56E−06 | 1.03E−06 | 7.27E−07 | −2.21E−07 |
| A12 | 0.00E+00 | 0.00E+00 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 | 0.00E+00 | 0.00E+00 |

In the second embodiment, the values of various conditions for the optical imaging lens 20 are listed in Table 5. From Table 5, it can be seen that the optical imaging lens 20 of the second embodiment satisfies the requirements of conditions (1) to (23).

TABLE 5
Second Embodiment

| No. | Condition | value |
|---|---|---|
| 1 | (CT2 − CT1)/AT12 | −0.080 |
| 2 | R1/CT1 | 26.461 |
| 3 | R3/CT2 | 39.217 |
| 4 | R1/f1 | −2.053 |
| 5 | R3/f2 | −5.541 |
| 6 | R3/EFL | 9.133 |
| 7 | f2/EFL | −1.648 |
| 8 | (CT3 + CT4)/AT34 | 2.433 |
| 9 | CT1/CT5 | 1.949 |
| 10 | AT12/AT56 | 5.239 |
| 11 | AT34/EFL | 0.488 |
| 12 | EFL/CT5 | 7.221 |
| 13 | (f4 + f5)EFL | 0.229 |
| 14 | TTL/AT56 | 79.770 |
| 15 | TTL/CT5 | 50.835 |
| 16 | (R1 + R2)/f1 | −2.584 |
| 17 | (f5 + f6)/(CT5 + CT6) | −0.047 |
| 18 | ΣCT/CT5 | 20.206 |
| 19 | ΣAT/AT45 | 25.382 |
| 20 | CT5/f5 | −0.084 |
| 21 | (R1*R2)/f1 | −8.912 |
| 22 | (CT5 + CT6)/(f5 + f6) | −21.350 |
| 23 | R1/R2 | 3.868 |

FIG. 2B shows, from left to right, the astigmatism/field curvature curves, f-θ distortion curves and the longitudinal spherical aberration curves of the optical imaging lens 20. It can be seen from the astigmatism/field curvature curve (wavelength 550 nm), the aberration in the sagittal direction(S) varies between −0.05 to −0.01 mm across the entire field of view, while the aberration in the tangential direction (T) varies between −0.02 to 0.01 mm. From the f-θ distortion curve (wavelength 550 nm), it can be observed that the absolute value of the f-θ distortion rate of the optical imaging lens 20 is less than 13%. From the longitudinal spherical aberration curve, it can be seen that off-axis light rays at three infrared wavelengths—470 nm, 555 nm, and 650 nm—can all converge near the imaging point. The deviation of the imaging point can be controlled within the range of −0.02 to 0.04 mm. As shown in FIG. 2B, the optical imaging lens 20 of this embodiment has effectively corrected various aberrations, meeting the imaging quality requirements of the optical system.

### Third Embodiment

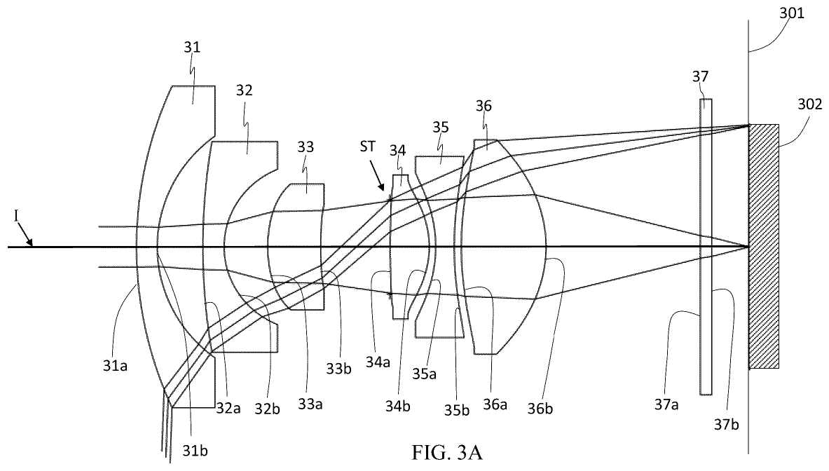

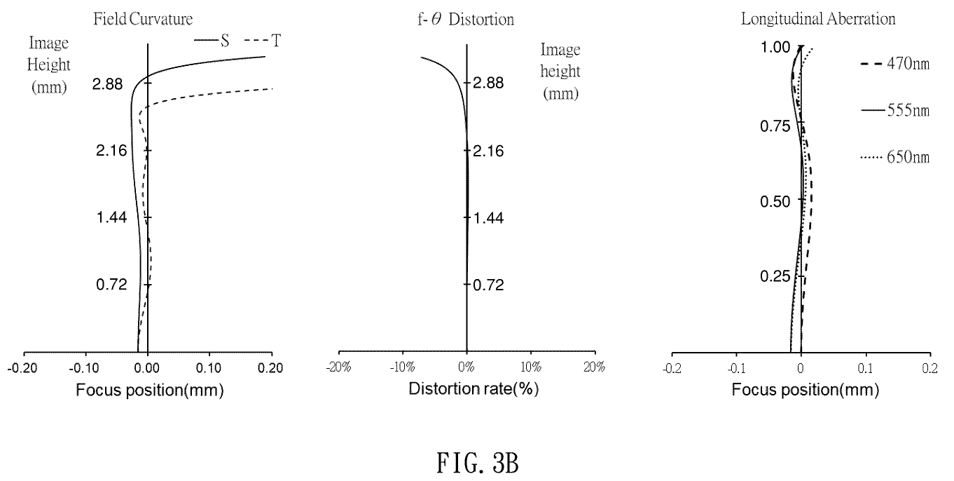

Referring to FIGS. 3A and 3B, FIG. 3A is a schematic view of an optical imaging lens of a third embodiment according to the present invention. FIG. 3B, from left to right, shows the astigmatism/field curvature curves, f-θ distortion curves, and the longitudinal spherical aberration curves of the optical imaging lens according to the third embodiment.

As shown in FIG. 3A, the optical imaging lens 30 of the third embodiment includes, in order from an object side to an image side, a first lens 31, a second lens 32, a third lens 33, an aperture stop ST, a fourth lens 34, and a fifth lens 35 and a sixth lens 36. The optical imaging lens 30 may further include a filter unit 37, and an image plane 301. An image sensor 302 could be disposed on the image plane 301 of the optical imaging lens 30 to form an imaging device (not labeled).

The first lens 31 has negative refractive power. Its object-side surface 31a is convex while its image-side surface 31b is concave. Both of the object-side surface 31a and the image-side surface 31b are spherical. The material of the first lens 31 includes glass, but is not limited thereto.

The second lens 32 has negative refractive power. Its object-side surface 32a is convex while its image-side surface 32b is concave. Both of the object-side surface 32a and the image-side surface 32b are spherical. The material of the second lens 32 includes glass, but is not limited thereto.

The third lens 33 has positive refractive power. Its object-side surface 33a is convex while its image-side surface 33b is concave. Both of the object-side surface 33a and the image-side surface 33b are spherical. The material of third lens 33 includes plastic, but is not limited thereto.

The fourth lens 34 has positive refractive power. Its object-side surface 34a is convex, and its image-side surface 34b is also convex. Both of the object-side surface 34a and the image-side surface 34b are aspheric. The material of fourth lens 34 includes plastic, but is not limited thereto.

The fifth lens 35 has negative refractive power. Its object-side surface 35a is concave, and its image-side surface 35b is also concave. Both of the object-side surface 35a and the image-side surface 35b are aspheric. The material of fifth lens 35 includes plastic, but is not limited thereto.

The sixth lens 36 has positive refractive power. Its object-side surface 36a is convex, and its image-side surface 36b is also convex. Both of the object-side surface 36a and the image-side surface 36b are aspheric. The material of sixth lens 36 includes plastic, but is not limited thereto.

The filter unit 37 is positioned between the sixth lens 36 and the image plane 303 to filter out light of specific wavelength, allowing the desired wavelengths to pass through. For example, it can be a component for filtering ultraviolet or far-infrared light. Both surfaces 37a and 37b of the filter unit 37 are flat, and the material is glass.

The image sensor 302 can be a CCD image sensor or CMOS image sensor.

The detailed optical data and aspherical coefficients of the lens surfaces for the optical imaging lens 30 in the third embodiment are listed in Table 6 and Table 7, respectively. In the third embodiment, the aspherical surface equation is expressed in the same form as in the first embodiment.

TABLE 6
Third Embodiment
TTL = 16.105 mm, EFL = 2.21 mm, FNO = 2, HFOV = 88°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | | | | |
| 1st lens | 31a | Spherical | 10.601 | 0.545 | 1.729 | 54.7 | −8.14 |
| | | Surface | | | | | |
| | 31b | Spherical | 3.729 | 1.198 | | | |
| | | Surface | | | | | |
| 2nd lens | 32a | Spherical | 17.237 | 0.557 | 1.729 | 54.7 | −3.64 |
| | | Surface | | | | | |
| | 32b | Aspherical | 2.273 | 1.146 | | | |
| | | Surface | | | | | |
| 3rd lens | 33a | Aspherical | 3.579 | 1.392 | 1.661 | 20.4 | 6.97 |
| | | Surface | | | | | |
| | 33b | Spherical | 13.144 | 1.804 | | | |
| | | Surface | | | | | |
| Aperture | ST | Flat | Infinity | 0.019 | | | |
| Stop | | | | | | | |
| 4th lens | 34a | Aspherical | 21.264 | 1.026 | 1.537 | 56.0 | 4.26 |
| | | Surface | | | | | |
| | 34b | Aspherical | −2.527 | 0.169 | | | |
| | | Surface | | | | | |
| 5th lens | 35a | Aspherical | −3.679 | 0.486 | 1.661 | 20.4 | −3.93 |
| | | Surface | | | | | |
| | 35b | Aspherical | 9.591 | 0.185 | | | |
| | | Surface | | | | | |
| 6th lens | 36a | Aspherical | 8.211 | 2.229 | 1.731 | 53.9 | 3.66 |
| | | Surface | | | | | |
| | 36b | Spherical | −3.529 | 4.051 | | | |
| | | Surface | | | | | |
| Filter Unit | 37a | Flat | Infinity | 0.300 | 1.523 | 54.5 | inf |
| | 37b | Flat | Infinity | 1.000 | | | |
| Image Plane | 301 | Flat | Infinity | 0.000 | | | |

Reference Wavelength: 550 nm

TABLE 7
Third Embodiment_Aspherical Surface Coefficient

| | 32b | 33a | 33b | 34a | 34b | 35a | 35b | 36a |
|---|---|---|---|---|---|---|---|---|
| K | 2.25E+00 | 9.10E+01 | 0.00E+00 | −7.85E−01 | 0.00E+00 | 0.00E+00 | −1.19E+01 | −1.65E+00 |
| A4 | 3.44E−03 | 1.13E−02 | 0.00E+00 | 7.18E−04 | 1.05E−03 | −2.85E−04 | −5.44E−04 | −3.23E−03 |
| A6 | 1.79E−03 | −1.84E−04 | 0.00E+00 | 1.84E−04 | −1.76E−04 | −1.65E−04 | 1.16E−04 | −2.04E−05 |
| A8 | −6.55E−04 | 1.19E−03 | 0.00E+00 | −1.26E−04 | 9.15E−05 | −2.15E−05 | −1.68E−05 | 2.21E−06 |
| A10 | 1.96E−04 | 2.49E−04 | 0.00E+00 | 2.92E−04 | 3.21E−05 | 1.88E−06 | 7.91E−07 | 4.79E−07 |
| A12 | 0.00E+00 | 0.00E+00 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 | 0.00E+00 | 0.00E+00 |

In the third embodiment, the values of various conditions for the optical imaging lens 30 are listed in Table 8. From Table 8, it can be seen that the optical imaging lens 30 of the third embodiment satisfies the requirements of conditions (1) to (23).

TABLE 8
Third Embodiment

| No. | Condition | value |
|---|---|---|
| 1 | (CT2 − CT1)/AT12 | 0.010 |
| 2 | R1/CT1 | 19.446 |
| 3 | R3/CT2 | 30.950 |
| 4 | R1/f1 | −1.303 |
| 5 | R3/f2 | −4.739 |
| 6 | R3/EFL | 7.800 |
| 7 | f2/EFL | −1.646 |
| 8 | (CT3 + CT4)/AT34 | 1.341 |
| 9 | CT1/CT5 | 1.121 |
| 10 | AT12/AT56 | 6.490 |
| 11 | AT34/EFL | 0.816 |
| 12 | EFL/CT5 | 4.545 |
| 13 | (f4 + f5)EFL | 0.149 |
| 14 | TTL/AT56 | 87.280 |
| 15 | TTL/CT5 | 33.118 |
| 16 | (R1 + R2)/f1 | −1.762 |
| 17 | (f5 + f6)/(CT5 + CT6) | −0.098 |
| 18 | ΣCT/CT5 | 12.822 |
| 19 | ΣAT/AT45 | 26.611 |
| 20 | CT5/f5 | −0.124 |
| 21 | (R1*R2)/f1 | −4.859 |
| 22 | (CT5 + CT6)/(f5 + f6) | −10.206 |
| 23 | R1/R2 | 2.843 |

FIG. 3B shows, from left to right, the astigmatism/field curvature curves, f-θ distortion curves and the longitudinal spherical aberration curves of the optical imaging lens 30. It can be seen from the astigmatism/field curvature curve (wavelength 550 nm), the aberration in the sagittal direction(S) varies between −0.03 to 0.19 mm across the entire field of view, while the aberration in the tangential direction (T) varies between −0.02 to 3.66 mm. From the f-θ distortion curve (wavelength 550 nm), it can be observed that the absolute value of the f-θ distortion rate of the optical imaging lens 30 is less than 7%. From the longitudinal spherical aberration curve, it can be seen that off-axis light rays at three infrared wavelengths—470 nm, 555 nm, and 650 nm—can all converge near the imaging point. The deviation of the imaging point can be controlled within the range of −0.02 to 0.02 mm. As shown in FIG. 3B, the optical imaging lens 30 of this embodiment has effectively corrected various aberrations, meeting the imaging quality requirements of the optical system.

### Fourth Embodiment

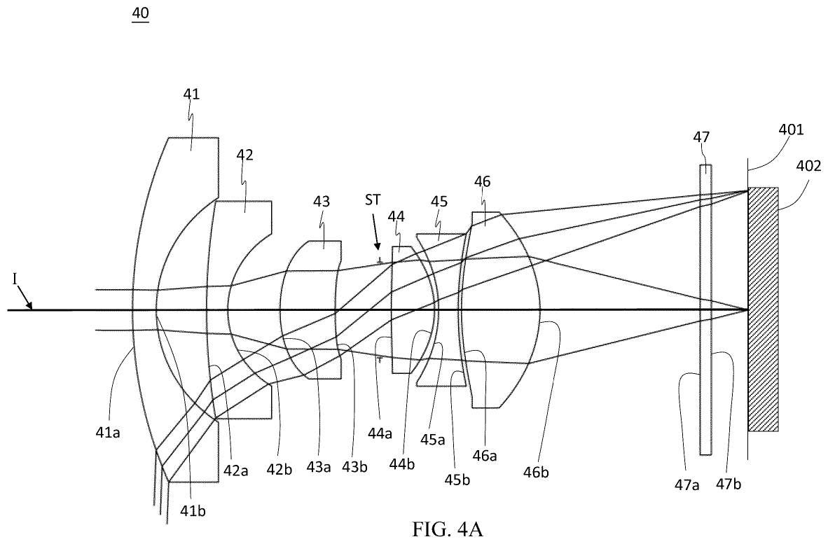

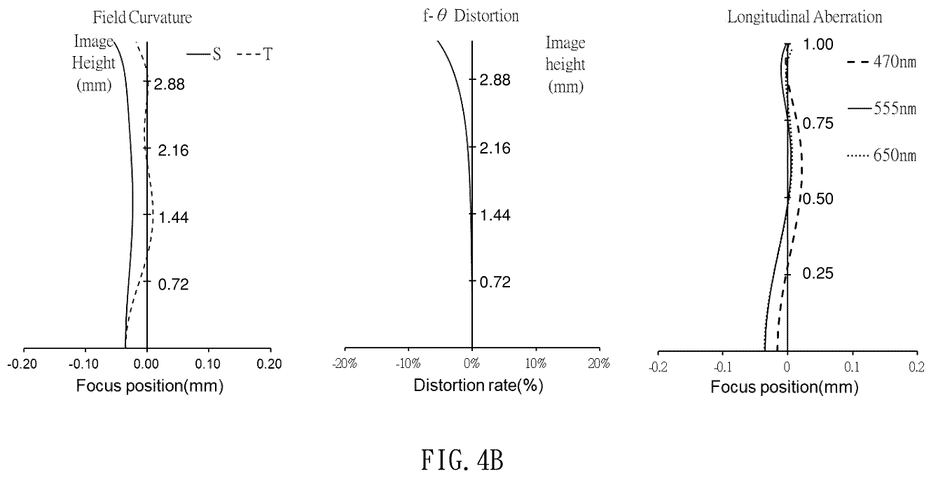

Referring to FIGS. 4A and 4B, FIG. 4A is a schematic view of an optical imaging lens of a fourth embodiment according to the present invention. FIG. 4B, from left to right, shows the astigmatism/field curvature curves, f-θ distortion curves, and the longitudinal spherical aberration curves of the optical imaging lens according to the fourth embodiment.

As shown in FIG. 4A, the optical imaging lens 40 of the third embodiment includes, in order from an object side to an image side, a first lens 41, a second lens 42, a third lens 43, an aperture stop ST, a fourth lens 44, and a fifth lens 45 and a sixth lens 46. The optical imaging lens 40 may further include a filter unit 47, and an image plane 401. An image sensor 404 could be disposed on the image plane 401 of the optical imaging lens 40 to form an imaging device (not labeled).

The first lens 41 has negative refractive power. Its object-side surface 41a is convex while its image-side surface 41b is concave. Both of the object-side surface 41a and the image-side surface 42b are spherical. The material of the first lens 41 includes glass, but is not limited thereto.

The second lens 42 has negative refractive power. Its object-side surface 42a is convex while its image-side surface 42b is concave. Both of the object-side surface 42a and the image-side surface 42b are spherical. The material of the second lens 42 includes glass, but is not limited thereto.

The third lens 43 has positive refractive power. Its object-side surface 43a is convex while its image-side surface 43b is concave. Both of the object-side surface 43a and the image-side surface 43b are spherical. The material of third lens 43 includes plastic, but is not limited thereto.

The fourth lens 44 has positive refractive power. Its object-side surface 44a is convex and its image-side surface 44b is also convex. Both of the object-side surface 44a and the image-side surface 44b are aspheric. The material of third lens 44 includes plastic, but is not limited thereto.

The fifth lens 45 has negative refractive power. Its object-side surface 45a is concave, and its image-side surface 45b is also concave. Both of the object-side surface 45a and the image-side surface 45b are aspheric. The material of fifth lens 45 includes plastic, but is not limited thereto.

The sixth lens 46 has positive refractive power. Its object-side surface 46a is convex, and its image-side surface 46b is also convex. Both of the object-side surface 46a and the image-side surface 46b are aspheric. The material of sixth lens 46 includes plastic, but is not limited thereto.

The filter unit 47 is positioned between the sixth lens 46 and the image plane 404 to filter out light of specific wavelength, allowing the desired wavelengths to pass through. For example, it can be a component for filtering ultraviolet or far-infrared light. Both surfaces 47a and 47b of the filter unit 47 are flat, and the material is glass.

The image sensor 402 can be a CCD image sensor or CMOS image sensor.

The detailed optical data and aspherical coefficients of the lens surfaces for the optical imaging lens 40 in the fourth embodiment are listed in Table 9 and Table 10, respectively. In the fourth embodiment, the aspherical surface equation is expressed in the same form as in the first embodiment.

TABLE 9
Fourth Embodiment
TTL = 16.51 mm, EFL = 2.267 mm, FNO = 2, HFOV = 88°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | | | | |
| 1st lens | 41a | Spherical | 12.151 | 0.636 | 1.729 | 54.7 | −7.55 |
| | | Surface | | | | | |
| | 41b | Spherical | 3.714 | 1.347 | | | |
| | | Surface | | | | | |
| 2nd lens | 42a | Spherical | 18.423 | 0.568 | 1.729 | 54.7 | −3.95 |
| | | Surface | | | | | |
| | 42b | Spherical | 2.462 | 1.399 | | | |
| | | Surface | | | | | |
| 3rd lens | 43a | Aspherical | 3.673 | 1.478 | 1.661 | 20.4 | 7.30 |
| | | Surface | | | | | |
| | 43b | Aspherical | 12.525 | 1.201 | | | |
| | | Surface | | | | | |
| Aperture | ST | Flat | Infinity | 0.302 | | | |
| Stop | | | | | | | |
| 4th lens | 44a | Aspherical | 22.826 | 1.158 | 1.537 | 56.0 | 4.32 |
| | | Surface | | | | | |
| | 44b | Aspherical | −2.546 | 0.112 | | | |
| | | Surface | | | | | |
| 5th lens | 45a | Aspherical | −3.589 | 0.521 | 1.661 | 20.4 | −3.90 |
| | | Surface | | | | | |
| | 45b | Aspherical | 9.960 | 0.090 | | | |
| | | Surface | | | | | |
| 6th lens | 46a | Aspherical | 8.180 | 2.107 | 1.731 | 53.9 | 3.74 |
| | | Surface | | | | | |
| | 46b | Aspherical | −3.629 | 4.286 | | | |
| | | Surface | | | | | |
| Filter Unit | 47a | Flat | Infinity | 0.300 | 1.523 | 54.5 | inf |
| | 47b | Flat | Infinity | 1.000 | | | |
| Image Plane | 401 | Flat | Infinity | 0.000 | | | |

Reference Wavelength: 550 nm

TABLE 10
Fourth Embodiment_Aspherical Surface Coefficient

| | 43a | 43b | 44a | 44b | 45a | 45b | 46a | 46b |
|---|---|---|---|---|---|---|---|---|
| K | 1.88E+00 | 7.24E+01 | −1.26E+02 | −6.30E−01 | 0.00E+00 | 0.00E+00 | −1.02E+01 | −1.68E+00 |
| A4 | 2.26E−03 | 1.25E−02 | −3.05E−03 | 1.53E−04 | 8.57E−04 | −2.65E−04 | −5.60E−04 | −3.07E−03 |
| A6 | 2.01E−03 | −2.90E−04 | −5.58E−05 | 5.38E−05 | 7.30E−05 | −1.92E−05 | 8.01E−05 | 5.49E−06 |
| A8 | −6.34E−04 | 8.53E−04 | 2.70E−05 | −9.37E−05 | 4.03E−05 | −6.78E−06 | −1.42E−05 | 6.10E−07 |
| A10 | 1.47E−04 | 2.15E−04 | 1.40E−05 | 1.72E−05 | −5.91E−06 | 6.07E−08 | 6.60E−07 | −2.66E−07 |
| A12 | 0.00E+00 | 0.00E+00 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 | 0.00E+00 | 0.00E+00 |

In the fourth embodiment, the values of various conditions for the optical imaging lens 40 are listed in Table 11. From Table 11, it can be seen that the optical imaging lens 40 of the fourth embodiment satisfies the requirements of conditions (1) to (23).

TABLE 11
Fourth Embodiment

| No. | Condition | value |
|---|---|---|
| 1 | (CT2 − CT1)/AT12 | −0.050 |
| 2 | R1/CT1 | 19.102 |
| 3 | R3/CT2 | 32.414 |
| 4 | R1/f1 | −1.609 |
| 5 | R3/f2 | −4.670 |
| 6 | R3/EFL | 8.127 |
| 7 | f2/EFL | −1.740 |
| 8 | (CT3 + CT4)/AT34 | 2.195 |
| 9 | CT1/CT5 | 1.220 |
| 10 | AT12/AT56 | 15.005 |
| 11 | AT34/EFL | 0.530 |
| 12 | EFL/CT5 | 4.348 |
| 13 | (f4 + f5)EFL | 0.187 |
| 14 | TTL/AT56 | 183.880 |
| 15 | TTL/CT5 | 31.668 |
| 16 | (R1 + R2)/f1 | −2.101 |
| 17 | (f5 + f6)/(CT5 + CT6) | −0.061 |
| 18 | ΣCT/CT5 | 12.408 |
| 19 | ΣAT/AT45 | 37.085 |
| 20 | CT5/f5 | −0.134 |
| 21 | (R1*R2)/f1 | −5.976 |
| 22 | (CT5 + CT6)/(f5 + f6) | −16.529 |
| 23 | R1/R2 | 3.271 |

FIG. 4B shows, from left to right, the astigmatism/field curvature curves, f-θ distortion curves and the longitudinal spherical aberration curves of the optical imaging lens 40. It can be seen from the astigmatism/field curvature curve (wavelength 550 nm), the aberration in the sagittal direction(S) varies between −0.05 to −0.02 mm across the entire field of view, while the aberration in the tangential direction (T) varies between −0.03 to 0.01 mm. From the f-θ distortion curve (wavelength 550 nm), it can be observed that the absolute value of the f-θ distortion rate of the optical imaging lens 40 is less than 6%. From the longitudinal spherical aberration curve, it can be seen that off-axis light rays at three infrared wavelengths—470 nm, 555 nm, and 650 nm—can all converge near the imaging point. The deviation of the imaging point can be controlled within the range of −0.04 to 0.01 mm. As shown in FIG. 4B, the optical imaging lens 40 of this embodiment has effectively corrected various aberrations, meeting the imaging quality requirements of the optical system.

### Fifth Embodiment

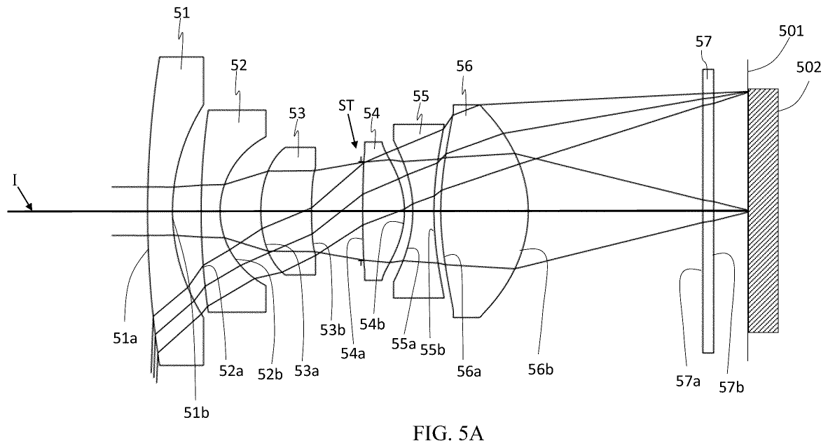

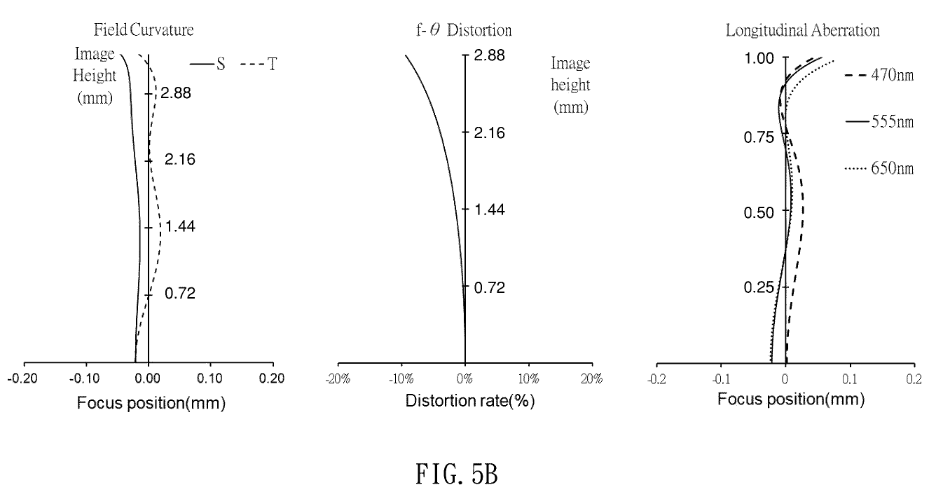

Referring to FIGS. 5A and 5B, FIG. 5A is a schematic view of an optical imaging lens of a fifth embodiment according to the present invention. FIG. 5B, from left to right, shows the astigmatism/field curvature curves, f-θ distortion curves, and the longitudinal spherical aberration curves of the optical imaging lens according to the fourth embodiment.

As shown in FIG. 5A, the optical imaging lens 50 of the fifth embodiment includes, in order from an object side to an image side, a first lens 51, a second lens 52, a third lens 53, an aperture stop ST, a fourth lens 54, and a fifth lens 55 and a sixth lens 56. The optical imaging lens 50 may further include a filter unit 57, and an image plane 501. An image sensor 505 could be disposed on the image plane 501 of the optical imaging lens 50 to form an imaging device (not labeled).

The first lens 51 has negative refractive power. Its object-side surface 51a is convex while its image-side surface 51b is concave. Both of the object-side surface 51a and the image-side surface 52b are spherical. The material of the first lens 51 includes glass, but is not limited thereto.

The second lens 52 has negative refractive power. Its object-side surface 52a is convex while its image-side surface 52b is concave. Both of the object-side surface 52a and the image-side surface 52b are spherical. The material of the second lens 52 includes glass, but is not limited thereto.

The third lens 53 has positive refractive power. Its object-side surface 53a is convex while its image-side surface 53b is concave. Both of the object-side surface 53a and the image-side surface 53b are spherical. The material of the third lens 53 includes plastic, but is not limited thereto.

The fourth lens 54 has positive refractive power. Its object-side surface 54a is convex and its image-side surface 54b is also convex. Both of the object-side surface 54a and the image-side surface 54b are aspheric. The material of fourth lens 44 includes plastic, but is not limited thereto.

The fifth lens 55 has negative refractive power. Its object-side surface 55a is concave, and its image-side surface 55b is also concave. Both of the object-side surface 55a and the image-side surface 55b are aspheric. The material of fifth lens 55 includes plastic, but is not limited thereto.

The sixth lens 56 has positive refractive power. Its object-side surface 56a is convex, and its image-side surface 56b is also convex. Both of the object-side surface 56a and the image-side surface 56b are aspheric. The material of sixth lens 56 includes plastic, but is not limited thereto.

The filter unit 57 is positioned between the sixth lens 56 and the image plane 505 to filter out light of specific wavelength, allowing the desired wavelengths to pass through. For example, it can be a component for filtering ultraviolet or far-infrared light. Both surfaces 57a and 57b of the filter unit 57 are flat, and the material is glass.

The image sensor 502 can be a CCD image sensor or CMOS image sensor.

The detailed optical data and aspherical coefficients of the lens surfaces for the optical imaging lens 50 in the fifth embodiment are listed in Table 12 and Table 13, respectively. In the fifth embodiment, the aspherical surface equation is expressed in the same form as in the first embodiment.

TABLE 12
Fifth Embodiment
TTL = 13.62 mm, EFL = 2.383 mm, FNO = 2.4, HFOV = 61.1°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | | | | |
| 1st lens | 51a | Spherical | 28.875 | 0.683 | 1.729 | 54.7 | −9.88 |
| | | Surface | | | | | |
| | 51b | Spherical | 5.724 | 0.783 | | | |
| | | Surface | | | | | |
| 2nd lens | 52a | Spherical | 20.694 | 0.520 | 1.729 | 54.7 | −3.73 |
| | | Surface | | | | | |
| | 52b | Spherical | 2.383 | 1.114 | | | |
| | | Surface | | | | | |
| 3rd lens | 53a | Aspherical | 3.627 | 1.389 | 1.661 | 20.4 | 7.11 |
| | | Surface | | | | | |
| | 53b | Aspherical | 13.046 | 1.363 | | | |
| | | Surface | | | | | |
| Aperture | ST | Flat | Infinity | 0.039 | | | |
| Stop | | | | | | | |
| 4th lens | 54a | Aspherical | 27.644 | 1.145 | 1.537 | 56.0 | 4.45 |
| | | Surface | | | | | |
| | 54b | Aspherical | −2.587 | 0.230 | | | |
| | | Surface | | | | | |
| 5th lens | 55a | Aspherical | −3.638 | 0.577 | 1.661 | 20.4 | −3.86 |
| | | Surface | | | | | |
| | 55b | Aspherical | 9.370 | 0.188 | | | |
| | | Surface | | | | | |
| 6th lens | 56a | Aspherical | 8.445 | 2.402 | 1.731 | 53.9 | 3.82 |
| | | Surface | | | | | |
| | 56b | Aspherical | −3.687 | 4.776 | | | |
| | | Surface | | | | | |
| Filter Unit | 57a | Flat | Infinity | 0.300 | 1.523 | 54.5 | inf |
| | 57b | Flat | Infinity | 1.000 | | | |
| Image Plane | 501 | Flat | Infinity | 0.000 | | | |

Reference Wavelength: 550 nm

TABLE 13
Fifth Embodiment_Aspherical Surface Coefficient

| | 53a | 53b | 54a | 54b | 55a | 55b | 56a | 56b |
|---|---|---|---|---|---|---|---|---|
| K | 1.93E+00 | 8.34E+01 | 5.26E+01 | −7.56E−01 | 0.00E+00 | 0.00E+00 | −1.05E+01 | −1.79E+00 |
| A4 | 2.77E−03 | 1.07E−02 | −4.30E−03 | 4.73E−04 | 2.69E−03 | −3.30E−04 | −7.33E−04 | −3.00E−03 |
| A6 | 1.97E−03 | −5.00E−05 | 1.27E−04 | 4.51E−04 | 1.44E−05 | −1.14E−04 | 6.56E−05 | −1.34E−05 |
| A8 | −6.41E−04 | 1.13E−03 | 5.80E−04 | −9.58E−05 | 9.49E−05 | −2.20E−05 | −1.13E−05 | 2.14E−06 |
| A10 | 1.69E−04 | −8.94E−05 | 1.33E−05 | 1.73E−04 | 2.31E−06 | 2.55E−06 | 6.26E−07 | −3.36E−08 |
| A12 | 0.00E+00 | 0.00E+00 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 | 0.00E+00 | 0.00E+00 |

In the third embodiment, the values of various conditions for the optical imaging lens 50 are listed in Table 14. From Table 14, it can be seen that the optical imaging lens 50 of the fifth embodiment satisfies the requirements of conditions (1) to (23).

TABLE 14
Fifth Embodiment

| No. | Condition | value |
|---|---|---|
| 1 | (CT2 − CT1)/AT12 | −0.208 |
| 2 | R1/CT1 | 42.290 |
| 3 | R3/CT2 | 39.805 |
| 4 | R1/f1 | −2.922 |
| 5 | R3/f2 | −5.554 |
| 6 | R3/EFL | 7.446 |
| 7 | f2/EFL | −1.341 |
| 8 | (CT3 + CT4)/AT34 | 1.858 |
| 9 | CT1/CT5 | 1.183 |
| 10 | AT12/AT56 | 4.174 |
| 11 | AT34/EFL | 0.491 |
| 12 | EFL/CT5 | 4.816 |
| 13 | (f4 + f5)EFL | 0.212 |
| 14 | TTL/AT56 | 87.899 |
| 15 | TTL/CT5 | 28.597 |
| 16 | (R1 + R2)/f1 | −3.502 |
| 17 | (f5 + f6)/(CT5 + CT6) | −0.013 |
| 18 | ΣCT/CT5 | 11.638 |
| 19 | ΣAT/AT45 | 15.963 |
| 20 | CT5/f5 | −0.150 |
| 21 | (R1*R2)/f1 | −16.726 |
| 22 | (CT5 + CT6)/(f5 + f6) | −78.393 |
| 23 | R1/R2 | 5.045 |

FIG. 5B shows, from left to right, the astigmatism/field curvature curves, f-θ distortion curves and the longitudinal spherical aberration curves of the optical imaging lens 50. It can be seen from the astigmatism/field curvature curve (wavelength 550 nm), the aberration in the sagittal direction(S) varies between −0.06 to −0.01 mm across the entire field of view, while the aberration in the tangential direction (T) varies between −0.04 to 0.02 mm. From the f-θ distortion curve (wavelength 550 nm), it can be observed that the absolute value of the f-θ distortion rate of the optical imaging lens 50 is less than 21%. From the longitudinal spherical aberration curve, it can be seen that off-axis light rays at three infrared wavelengths—470 nm, 555 nm, and 650 nm—can all converge near the imaging point. The deviation of the imaging point can be controlled within the range of −0.02 to 0.08 mm. As shown in FIG. 5B, the optical imaging lens 50 of this embodiment has effectively corrected various aberrations, meeting the imaging quality requirements of the optical system.

### Sixth Embodiment

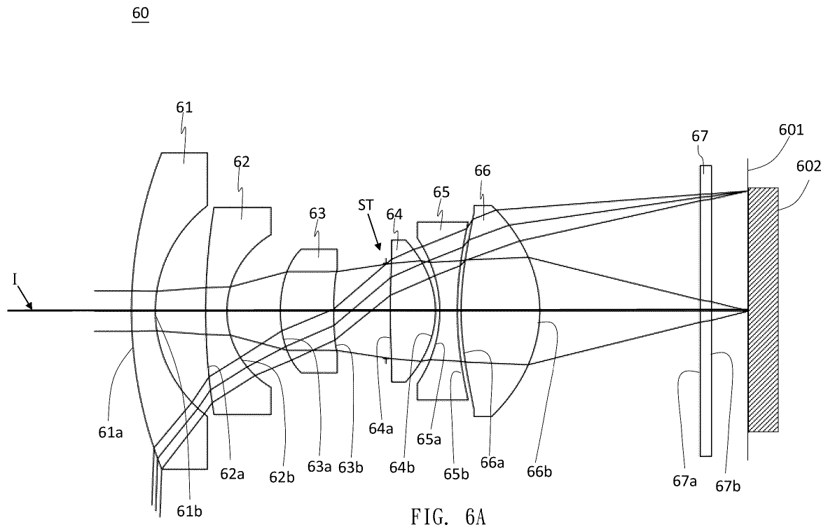

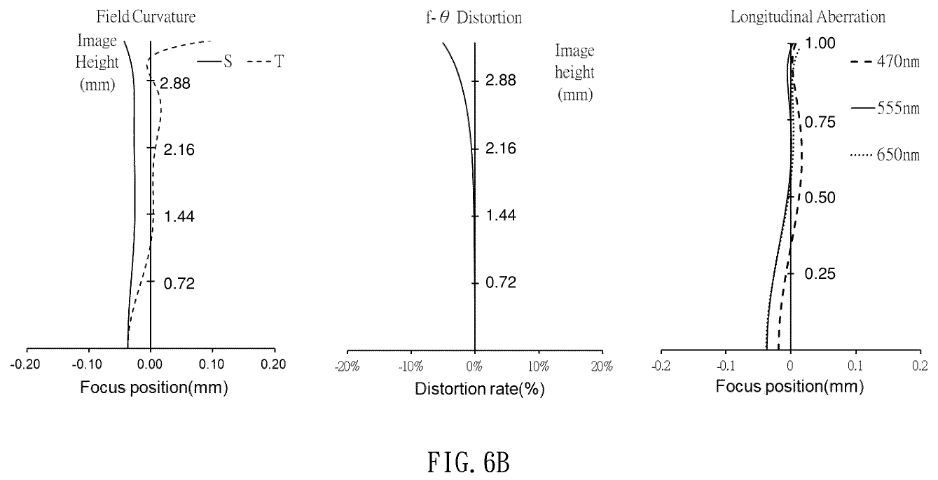

Referring to FIGS. 6A and 6B, FIG. 6A is a schematic view of an optical imaging lens of a sixth embodiment according to the present invention. FIG. 6B, from left to right, shows the astigmatism/field curvature curves, f-θ distortion curves, and the longitudinal spherical aberration curves of the optical imaging lens according to the fourth embodiment.

As shown in FIG. 6A, the optical imaging lens 60 of the sixth embodiment includes, in order from an object side to an image side, a first lens 61, a second lens 62, a third lens 63, an aperture stop ST, a fourth lens 64, and a fifth lens 65 and a sixth lens 66. The optical imaging lens 60 may further include a filter unit 67, and an image plane 601. An image sensor 606 could be disposed on the image plane 601 of the optical imaging lens 60 to form an imaging device (not labeled).

The first lens 61 has negative refractive power. Its object-side surface 61a is convex while its image-side surface 61b is concave. Both of the object-side surface 61a and the image-side surface 62b are spherical. The material of the first lens 61 includes glass, but is not limited thereto.

The second lens 62 has negative refractive power. Its object-side surface 62a is convex while its image-side surface 62b is concave. Both of the object-side surface 62a and the image-side surface 62b are spherical. The material of the second lens 62 includes glass, but is not limited thereto.

The third lens 63 has positive refractive power. Its object-side surface 63a is convex while its image-side surface 63b is concave. Both of the object-side surface 63a and the image-side surface 63b are spherical. The material of the third lens 63 includes plastic, but is not limited thereto.

The fourth lens 64 has positive refractive power. Its object-side surface 64a is convex and its image-side surface 64b is also convex. Both of the object-side surface 64a and the image-side surface 64b are aspheric. The material of fourth lens 64 includes plastic, but is not limited thereto.

The fifth lens 65 has negative refractive power. Its object-side surface 65a is concave and its image-side surface 65b is also concave. Both of the object-side surface 65a and the image-side surface 65b are aspheric. The material of fifth lens 65 includes plastic, but is not limited thereto.

The sixth lens 66 has positive refractive power. Its object-side surface 66a is convex and its image-side surface 66b is also convex. Both of the object-side surface 66a and the image-side surface 66b are aspheric. The material of sixth lens 66 includes plastic, but is not limited thereto.

The filter unit 67 is positioned between the sixth lens 66 and the image plane 606 to filter out light of specific wavelength, allowing the desired wavelengths to pass through. For example, it can be a component for filtering ultraviolet or far-infrared light. Both surfaces 67a and 67b of the filter unit 67 are flat, and the material is glass.

The image sensor 602 can be a CCD image sensor or CMOS image sensor.

The detailed optical data and aspherical coefficients of the lens surfaces for the optical imaging lens 60 in the sixth embodiment are listed in Table 15 and Table 16, respectively. In the sixth embodiment, the aspherical surface equation is expressed in the same form as in the first embodiment.

TABLE 15
Sixth Embodiment
TTL = 16.648 mm, EFL = 2.913 mm, FNO = 2.4, HFOV = 60.8°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | | | | |
| 1st lens | 61a | Spherical | 12.151 | 0.636 | 1.729 | 54.7 | −7.53 |
| | | Surface | | | | | |
| | 61b | Spherical | 3.714 | 1.347 | | | |
| | | Surface | | | | | |
| 2nd lens | 62a | Spherical | 18.423 | 0.568 | 1.729 | 54.7 | −3.95 |
| | | Surface | | | | | |
| | 62b | Spherical | 2.462 | 1.425 | | | |
| | | Surface | | | | | |
| 3rd lens | 63a | Aspherical | 3.653 | 1.428 | 1.661 | 20.4 | 7.28 |
| | | Surface | | | | | |
| | 63b | Aspherical | 12.435 | 1.394 | | | |
| | | Surface | | | | | |
| Aperture | ST | Flat | Infinity | 0.120 | | | |
| Stop | | | | | | | |
| 4th lens | 64a | Aspherical | 23.458 | 1.207 | 1.537 | 56.0 | 4.33 |
| | | Surface | | | | | |
| | 64b | Aspherical | −2.544 | 0.115 | | | |
| | | Surface | | | | | |
| 5th lens | 65a | Aspherical | −3.588 | 0.468 | 1.661 | 20.4 | −3.88 |
| | | Surface | | | | | |
| | 65b | Aspherical | 9.820 | 0.102 | | | |
| | | Surface | | | | | |
| 6th lens | 66a | Aspherical | 8.180 | 2.107 | 1.731 | 53.9 | 3.74 |
| | | Surface | | | | | |
| | 66b | Aspherical | −3.629 | 4.286 | | | |
| | | Surface | | | | | |
| Filter Unit | 67a | Flat | Infinity | 0.300 | 1.523 | 54.5 | ing |
| | 67b | Flat | Infinity | 1.000 | | | |
| Image Plane | 601 | Flat | Infinity | 0.000 | | | |

Reference Wavelength: 550 nm

TABLE 16
Sixth Embodiment_Aspherical Surface Coefficient

| | 63a | 63b | 64a | 64b | 65a | 65b | 66a | 66b |
|---|---|---|---|---|---|---|---|---|
| K | 1.89E+00 | 8.10E+01 | −1.13E+02 | −6.26E−01 | 0.00E+00 | 0.00E+00 | −1.02E+01 | −1.68E+00 |
| A4 | 3.23E−03 | 1.26E−02 | −2.96E−03 | 9.77E−05 | 7.69E−04 | −1.94E−04 | −5.60E−04 | −3.07E−03 |
| A6 | 1.99E−03 | 2.00E−04 | −8.51E−05 | 4.22E−05 | 3.21E−05 | −3.99E−05 | 8.01E−05 | 5.49E−06 |
| A8 | −6.10E−04 | 8.96E−04 | 3.16E−05 | −8.95E−05 | 2.91E−05 | −1.14E−05 | −1.42E−05 | 6.10E−07 |
| A10 | 1.69E−04 | −6.93E−05 | 4.92E−05 | 2.17E−05 | −1.03E−05 | 9.48E−07 | 6.60E−07 | −2.66E−07 |
| A12 | 0.00E+00 | 0.00E+00 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 | 0.00E+00 | 0.00E+00 |

In the sixth embodiment, the values of various conditions for the optical imaging lens 60 are listed in Table 17. From Table 17, it can be seen that the optical imaging lens 60 of the sixth embodiment satisfies the requirements of conditions (1) to (23).

TABLE 17
Sixth Embodiment

| No. | Condition | Value |
|---|---|---|
| 1 | (CT2 − CT1)/AT12 | −0.050 |
| 2 | R1/CT1 | 19.102 |
| 3 | R3/CT2 | 32.414 |
| 4 | R1/f1 | −1.613 |
| 5 | R3/f2 | −4.670 |
| 6 | R3/EFL | 8.148 |
| 7 | f2/EFL | −1.745 |
| 8 | (CT3 + CT4)/AT34 | 1.891 |
| 9 | CT1/CT5 | 1.360 |
| 10 | AT12/AT56 | 13.239 |
| 11 | AT34/EFL | 0.616 |
| 12 | EFL/CT5 | 4.833 |
| 13 | (f4 + f5)EFL | 0.198 |
| 14 | TTL/AT56 | 162.147 |
| 15 | TTL/CT5 | 35.266 |
| 16 | (R1 + R2)/f1 | −2.106 |
| 17 | (f5 + f6)/(CT5 + CT6) | −0.057 |
| 18 | ΣCT/CT5 | 13.711 |
| 19 | ΣAT/AT45 | 38.158 |
| 20 | CT5/f5 | −0.120 |
| 21 | (R1*R2)/f1 | −5.991 |
| 22 | (CT5 + CT6)/(f5 + f6) | −17.396 |
| 23 | R1/R2 | 3.271 |

FIG. 6B shows, from left to right, the astigmatism/field curvature curves, f-θ distortion curves and the longitudinal spherical aberration curves of the optical imaging lens 60. It can be seen from the astigmatism/field curvature curve (wavelength 550 nm), the aberration in the sagittal direction(S) varies between −0.04 to −0.03 mm across the entire field of view, while the aberration in the tangential direction (T) varies between −0.04 to 0.10 mm. From the f-θ distortion curve (wavelength 555 nm), it can be observed that the absolute value of the f-θ distortion rate of the optical imaging lens 60 is less than 5%. From the longitudinal spherical aberration curve, it can be seen that off-axis light rays at three infrared wavelengths—470 nm, 555 nm, and 650 nm—can all converge near the imaging point. The deviation of the imaging point can be controlled within the range of −0.04 to 0.02 mm. As shown in FIG. 6B, the optical imaging lens 60 of this embodiment has effectively corrected various aberrations, meeting the imaging quality requirements of the optical system.

### Seventh Embodiment

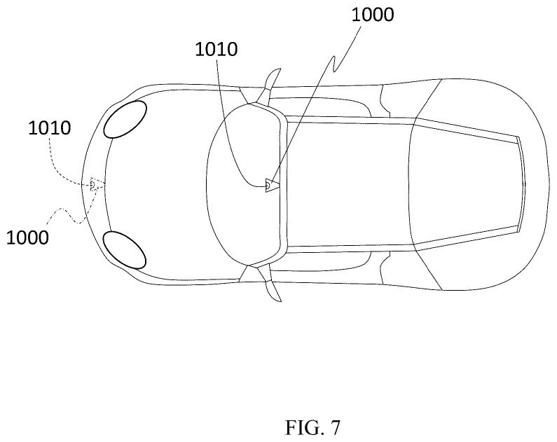

Referring to FIG. 7, an imaging device 1010 comprises an optical imaging lens 10, 20, 30, 40, 50, 60 described in the first to sixth embodiments, and an image sensor 102, 202, 302, 402, 502, 602; wherein the image sensor 102, 202, 302, 402, 502, 602 is disposed on an image plane 101, 201, 301, 401, 501, 601 of the optical imaging lens 10, 20, 30, 40, 50, 60. The image sensor 102, 202, 302, 402, 502, 602 can be Charge-Coupled Devices (CCD) or Complementary Metal Oxide Semiconductor (CMOS) image sensors.

In FIG. 7, an automotive electronic device 1000 according to the seventh embodiment of the present invention includes an imaging device 1010, wherein the automotive electronic device 1000 is used for observing, monitoring, sensing, and/or recording objects or human behaviors and actions inside and outside the vehicle.

### Eight Embodiment

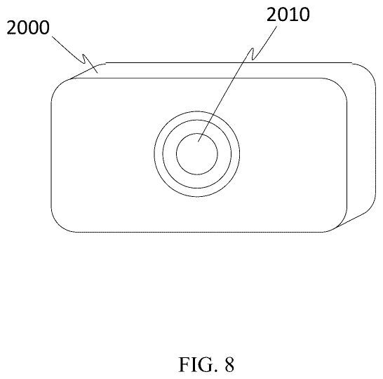

In FIG. 8, the electronic device 2000 according to the eighth embodiment of the present invention includes image device 2010, wherein the electronic device 2000 can be applied to general 3C products and other electronic devices with imaging functions.

Although the present invention has been described with reference to several embodiments, these embodiments are not intended to limit the scope of the invention. For those skilled in the art, various changes in form and details may be made without departing from the spirit and scope of the invention, based on the embodiments disclosed herein. Accordingly, it should be understood that the invention is to be defined by the appended claims, and all variations and modifications within the scope of the claims or their equivalents are intended to be encompassed by the invention.

What is claimed is:

1. An optical imaging lens, in order from an object side to an image side, comprising:
a first lens with negative refractive power having an object-side surface being convex and an image-side surface being concave;
a second lens with negative refractive power having an object-side surface being convex and an image-side surface being concave;
a third lens with positive refractive power having an object-side surface being convex and an image-side surface being concave;
an aperture stop;
a fourth lens with positive refractive power having an object-side surface being convex and an image-side surface being convex;
a fifth lens with negative refractive power having an object-side surface being concave and an image-side surface being concave; and
a sixth lens with positive refractive power having an object-side surface being convex and an image-side surface being convex;
wherein, a thickness of the second lens is CT2, a thickness of the first lens is CT1, an air gap from the first lens to the second lens is AT12, a curvature radius of the object-side surface of the the first lens is R1, a curvature radius of the object-side surface of the the second lens is R3, and the following conditions are satisfied:
−0.21<(CT2-CT1)/AT12<0.01;
18.4<R1/CT1<42.3; and
30.9<R3/CT2<50.5.

2. The optical imaging lens of claim 1, wherein a curvature radius of the object-side surface of the first lens is R1, a focal length of the first lens is f1, and the following condition is satisfied:
−3<R1/f1<−1.3.

3. The optical imaging lens of claim 1, wherein a curvature radius of an object-side surface of the the second lens is R3, a focal length of the second lens is f2, a focal length of the optical imaging lens is EFL, and the following conditions are satisfied:
−7.7<R3/f2<−4.6;
and −7.4<R3/EFL<12.7.

4. The optical imaging lens of claim 1, wherein a focal length of the second lens is f2, a focal length of the optical imaging lens is EFL, and the following condition is satisfied:
−1.8<f2/EFL<−1.3.

5. The optical imaging lens of claim 1, wherein a thickness of the third lens is CT3, a thickness of the fourth lens is CT4, and an air gap from the third lens to the fourth lens is AT34, and the following condition is satisfied:
1.3<(CT3+CT4)/AT34<3.9.

6. The optical imaging lens of claim 1, wherein a thickness of the first lens is CT1, a thickness of the fifth lens is CT5, and the following condition is satisfied:
1.1<CT1/CT5<2.6.

7. The optical imaging lens of claim 1, wherein an air gap from the first lens to the second lens is AT12, and an air gap from the fifth lens to the sixth lens is AT56, and the following condition is satisfied:
4.1<AT12/AT56<15.1.

8. The optical imaging lens of claim 1, wherein an air gap from the third lens to the fourth lens is AT34, a focal length of the optical imaging lens is EFL, and the following condition is satisfied:
0.3<AT34/EFL<0.82.

9. The optical imaging lens of claim 1, wherein a focal length of the optical
imaging lens is EFL, a thickness of the fifth lens is CT5, and the following condition is satisfied:
4.3<EFL/CT5<9.1.

10. The optical imaging lens of claim 1, wherein a focal length of the fourth lens is f4, a focal length of the fifth lens is f5, a focal length of the optical imaging lens is EFL, and the following condition is satisfied:
0.14<(f4+f5)EFL<0.25.

11. The optical imaging lens of claim 1, wherein a total track length of the optical imaging lens is TTL, an air gap from the fifth lens to the sixth lens is AT56, and the following conditions are satisfied:
74<TTL/AT56<184.

12. The optical imaging lens of claim 1, wherein a total track length of the optical imaging lens is TTL, a thickness of the fifth lens is CT5, and the following conditions are satisfied:
28<TTL/CT5<65.

13. The optical imaging lens of claim 1, wherein a curvature radius of an object-side surface of the the first lens is R1, a curvature radius of the image-side of the the first lens is R2, a focal length of the first lens is f1, and the following condition is satisfied:
−3.6<(R1+R2)/f1<−1.7.

14. The optical imaging lens of claim 1, wherein a focal length of the fifth lens is f5, a focal length of the sixth lens is f6, a thickness of the fifth lens is CT5, a thickness of the sixth lens is CT6, and the following condition is satisfied:
−0.1<(f5+f6)/(CT5+CT6)<−0.013.

15. The optical imaging lens of claim 1, wherein the total thickness of the lenses of the optical imaging lens at the optical axis is ECT, a thickness of the fifth lens is CT5, and the following condition is satisfied:
11<ΣCT/CT5<26.1.

16. The optical imaging lens of claim 1, wherein the lenses of the optical imaging lens are separated from each other by gaps, and the total width of these gaps at the optical axis is ΣAT, an air gap between the fourth and fifth lens is AT45, and the following condition is satisfied:
15<ΣAT/AT45<38.2.

17. The optical imaging lens of claim 1, wherein a thickness of the fifth lens is CT5, a thickness of the sixth lens is CT6, a focal length of fifth lens is f5, a focal length of sixth lens is f6, and the following conditions are satisfied:
−0.15<CT5/f5<−0.06;
and −79<(CT5+CT6)/(f5+f6)<−10.

18. The optical imaging lens of claim 1, wherein a curvature radius of an object-side surface of the the first lens is R1, a curvature radius of the image-side of the the first lens is R2, a focal length of the first lens is f1, and the following conditions are satisfied:
−17<(R1*R2)/f1<−4.8;
and 2.8<R1/R2<5.1.

19. An imaging device, comprising:
the optical imaging lens of claim 1; and
an electronic image sensor; wherein the image sensor is located on an image plane of the optical imaging lens.

20. An electronic device, comprising:
the imaging device of claim 19.
